(19) United States
(12) Patent Application Publication
(10) Pub. No.: US 2007/0266127 A1
(43) Pub. Date: Nov. 15, 2007

(54) INTERNAL VIRTUAL LOCAL AREA NETWORK (LAN)

(76) Inventor: Andrew Henry Richter, Chapel Hill, NC (US)

Correspondence Address: MOORE & VAN ALLEN, PLLC For IBM, P.O. Box 13706, Research Triangle Park, NC, 27709, US

(21) Appl. No.: 11/382,521

(22) Filed: May 10, 2006

(51) Int. Cl. G06F 15/173

(52) U.S. Cl. 709/223

(57) ABSTRACT

An internal virtual local area network (LAN). A system includes a plurality of internal, virtual LAN devices. Each virtual LAN device has a virtual address unique among the virtual LAN devices in the system. In some embodiments, a virtual LAN driver is coupled to the plurality of virtual LAN devices to transfer packets from an operating system to the virtual LAN devices using the virtual address. In this way, an internal virtual LAN can be formed in that the operating system can use a virtual LAN device address in the same manner as it can use a physical LAN device address.

### BACKGROUND OF THE INVENTION

Computing platforms such as workstations, servers, and personal computers connected via a local area network (LAN) are important because they offer computer users shared access to common computing resources. However, the common resources sometimes use differing protocol “stacks.” One taxonomy for describing LAN (and other network) interconnection protocol stacks is the “open systems interconnect” (OSI) reference model, which includes seven layers. In such a model, each device is associated with the layer in which it relays information to other devices. Layers four through seven are mostly related to the type of application that is exchanging information over the network. Layers one through three are mostly related to moving packets, no matter what data the packets contain, from one place to another.

Layer three is the “network layer” and establishes the route between devices. Below the network layer is layer two, the data link layer. The data link layer provides for physical transmission between nodes with unique physical addresses via medium access control (MAC) and logical link control. With protocols that closely follow the OSI model, the network layer protocol typically makes use of and needs awareness of the physical hardware addresses of nodes such as network adapters. These physical addresses are often referred to as “MAC” addresses.

Examples of network layer (layer three) protocols include Appletalk, and systems network architecture (SNA). However, the most ubiquitous layer three protocol is the internet protocol (IP) which is well-known as part of the TCP/IP protocol. Although TCP/IP is based on the OSI reference model, the TCP/IP protocol stack eliminates some of the layers, so that layers one and two are not used in routing IP traffic. One of the features of the TCP/IP protocol is that IP network traffic can be looped back between applications inside a single computer operating system image. This feature is enabled by the fact that IP traffic does not have to use MAC addresses for routing; therefore, physical network interfaces do not need to be present to supply the MAC addresses. When there is a need to “loop back” non-IP traffic between applications inside a single OS image, multiple network adapters, each with a MAC address, can be attached to the operating system, with traffic routed out of one and into another.

### BRIEF SUMMARY OF THE INVENTION

A system according to at least one embodiment of the invention includes a plurality of internal, virtual local area network (LAN) devices. In such an embodiment, each virtual LAN device has a virtual address unique among the virtual LAN devices in the system. In some embodiments, a virtual LAN driver is coupled to the plurality of virtual LAN devices to transfer packets from an operating system to the virtual LAN devices using the virtual address. In this way, an internal virtual LAN can be formed in that the operating system can use a virtual LAN device address in the same manner as it can use a physical LAN device address.

At least some embodiments of the invention manage a virtual LAN by identifying at least one virtual device coupled to the virtual LAN using virtual address information for the virtual device. Such an embodiment can identify a virtual device in response to receiving an application-originated packet through the operating system. Such an embodiment forwards the application-originated packet to the virtual device in response to the identifying of the device with the virtual address. Such an embodiment may take the form of, or be enabled by a computer program product including a computer usable medium encoded with computer usable program code. Such computer usable code coupled with an operating system and an appropriate instruction execution system can form the means to carry out embodiments of the invention.

### BRIEF DESCRIPTION OF THE SEVERAL VIEWS OF THE DRAWINGS

FIG. 1 is a block diagram illustrating an embodiment of the invention from an operating system perspective.

FIGS. 2 and 3 are flowcharts illustrating methods according to at least some embodiments of the invention.

FIG. 4 is a system block diagram illustrating an instruction execution system or platform implementing an example embodiment of the invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer usable or computer readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this document, a computer usable or computer readable medium may be any medium that can contain, store, communicate, propagate, or transport the program for use by or in connection with the instruction execution system, apparatus, or device. The computer usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF) or other means.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on one computer as a stand-alone software package, partly on a local computer and partly on a remote computer or entirely on the remote computer or server. In the latter scenario, the remote computer may be connected to the user's computer through a physical or another virtual local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Embodiments of the present invention can allow loop back functionality with non-IP protocols. As is known in the art, the IP protocol uses address resolution protocol (ARP) to obviate the need for an operating system to “know” the physical hardware address (also known as the MAC address or layer two address) of some physical devices. As an example, a network interface card (NIC) is typically assigned a MAC address. However, other network layer protocols need these physical addresses. For example, SNA uses configuration files to define these layer two addresses. The need for source and destination MAC addresses for routing may mean that non-IP protocols may not be able to use the same loop back mechanism as is used with IP protocols. Thus, the internal, virtual LAN according to at least some embodiments of the invention can allow applications to communicate with each other over virtual devices that do not correspond to any real hardware, but nevertheless can appear to an operating system, and hence to applications, to have all of the characteristics of real hardware devices. These virtual devices can respond to all operating system commands and user programs as if they were real hardware devices. Data can be transferred between devices based on layer two protocols. The devices can be set up to represent any type of hardware, Token Ring, Ethernet etc.

In example embodiments, all hardware headers are managed and used by a driver to cause applications to be able to send and receive packets. Such a driver may be referred to herein as an internal LAN or “iLAN” driver. Internal, virtual LAN devices, which may be referred to herein as iLAN devices, can be created and destroyed by a system administrator. In example embodiments, the MAC address and other settings, for example promiscuous mode, can be changed as needed. Any number of virtual devices can be defined. If needed, hundreds of iLAN devices can be defined. When the devices are displayed or modified they are changed using standard system tools, since the virtual devices appear to the operating system as real hardware devices.

In some embodiments, an internal, virtual LAN is created using standard operating system tools and functions and putting them to “nonstandard” use in order to create the iLAN driver and virtual devices. Once the virtual devices are created they are configured/controlled in the same manner as actual hardware devices. As an example, in a Linux system, the Linux kernel module can be made to “lie” to the Linux kernel. The invention can work with any operating system however, as long as the appropriate mechanism is used to set up the internal virtual LAN.

In an embodiment where the relevant hardware addresses used are MAC addresses, a system administrator can define whatever MAC addresses are convenient. For example, an actual hardware MAC address from another machine can be used to allow testing of an application that depends on that MAC address. Alternatively, addresses completely outside the range of “real” MAC addresses could be used. Staying with Linux as an example, the MAC address is normally set by the standard “ipconfig” command. Again, the invention is not restricted to a particular operating system and Linux is given here only as an example.

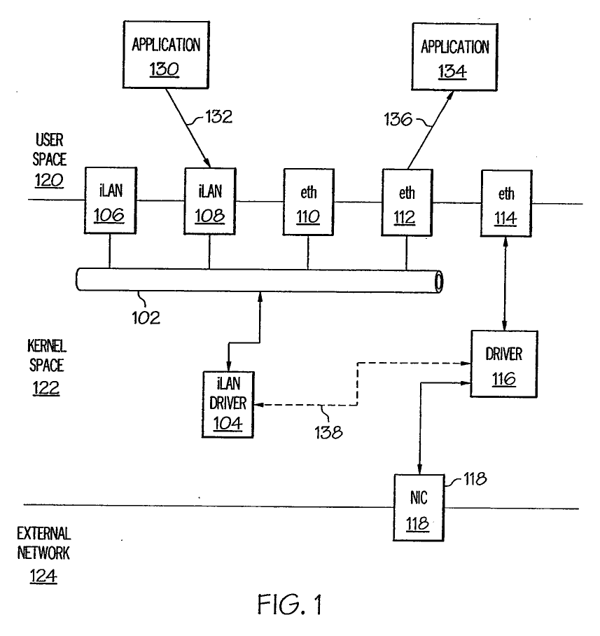

Turning to FIG. 1, a block diagram of an example embodiment of the invention is presented with the various elements of the system appearing as they would to an operating system and applications running under the operating system. An internal, virtual, LAN system according to embodiments of the invention is conceptually represented by LAN 102. LAN 102 functionally includes ILAN driver 104 and four virtual devices, each having a virtual hardware address. A system administrator or other user has designated two virtual devices, which are generic in nature, as iLAN device 106 and iLAN device 108. Virtual LAN 102 also includes two virtual Ethernet devices, Ethernet device 110 and Ethernet device 112. The system of FIG. 1 also includes a real Ethernet device, physical device 114. Device 114 has its own driver, driver 116, and a physical connection to a network via network interface card, 118, associated with the device and the external network from the point of view of the operating system.

Still referring to FIG. 1, the operating system in the illustrative embodiment includes user space 120, kernel space 122 and connectivity to an external network, 124. All of the devices, both actual and virtual, are accessed under control of the operating system kernel by applications in user space 120. Kernel space 122 sees real Ethernet device 114 as a portal to external network 124.

During operation, application 130 of the example system illustrated in FIG. 1 may send one or more packets of data to the virtual LAN. The data passes into the network layer and is prepared for transmission and queued to one of the iLAN virtual devices by iLAN driver 104. Packets of data being forwarded to an iLAN device by an application are represented by arrow 132. When an application originated packet is forwarded through the operating system in this manner, the layer two portion of the packet is examined by the iLAN driver so that the appropriate virtual device can be identified using the virtual address. The system then sends such a packet to the inbound queue of the destination virtual device. The virtual device queues the packet to the network layer as if it had come from the external network.

Still using the system of FIG. 1 as an example, the network layer can forward the data previously received from application 130 to application 134 via the same or a different virtual device. Date traversing in this direction is represented by arrow 136. A packet traversing from an internal, virtual device on the virtual iLAN to an application is treated like any other device originated packet. The operating system forwards it to an application, such as application 134. Application 134 does not know the difference between the virtual device 112, and a real network interface card presented to the user space as a real device. The applications do not have to be altered in order to take advantage of the virtual LAN. The network layer and operating system do not recognize the device as different from a physical device. In example embodiments of the invention, external monitors also see the device as a real, physical device, and report successfully and accurately on its use.

Still referring to FIG. 1, path 138, represented with a dashed line, illustrates an optional feature where the virtual LAN is bridged to the real, physical LAN. If such bridging is employed, packets from the virtual LAN can escape to the real LAN, and packets traversing the real LAN, both unicast and broadcast packets, can be seen on the virtual LAN. Such a configuration can be employed, for example, to enable moving applications from a crashed machine with a failed NIC to a backup machine without having to change the application configuration to allow for a new NIC with a different MAC address. Like many of the other traffic/signal paths illustrated in the figures, path 138 is conceptual in nature. Traffic over that path is passed under the control of the operating system.

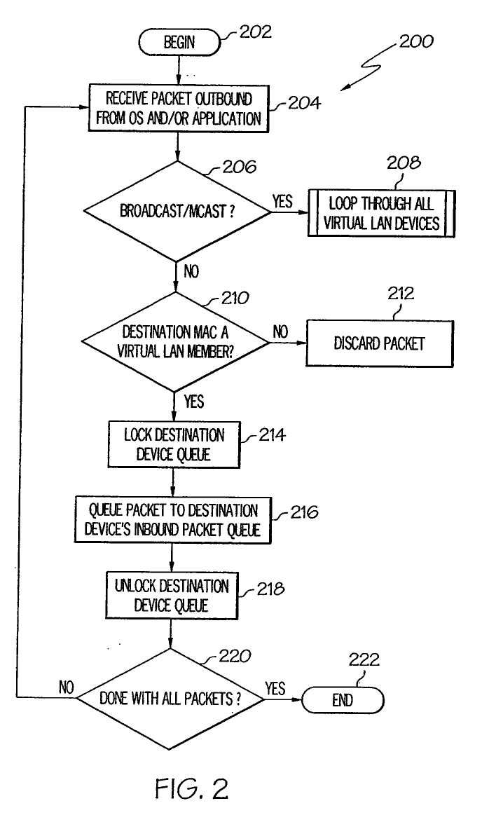

FIG. 2 presents a flowchart diagram illustrating a method, 200, of managing a virtual LAN according to at least some example embodiments of the present invention. Method 200 of FIG. 2 illustrates the processing of an application originated packet received through an operating system and routed by the previously discussed iLAN driver. Data traffic being handled by method 200 is conceptually represented by arrow 132 of FIG. 1. Method 200 begins at block 202. At block 204, the virtual LAN system receives a packet outbound from the operating system and/or an application. At block 206, the driver makes a determination as to whether the packet received is a broadcast or multicast packet. If so, the iLAN driver loops through all of the virtual LAN devices and delivers the packet at block 208. If not, the iLAN driver identifies the hardware address being used by the outbound packet. In the example embodiment of FIG. 2, the hardware address is a MAC address. If the packet is actually not directed to a virtual LAN member, the system discards the packet at block 212. Otherwise, the system identifies the virtual device and forwards the application originated packet to the virtual device once the device has been identified.

Still referring to FIG. 2, in order to forward a packet to a virtual device, the iLAN driver locks the destination device queue at block 214. The driver and/or system then queues the packet to the destination device's inbound packet queue at block 216. The iLAN system unlocks the destination device queue at block 218. At block 220, the system makes a determination as to whether all of the packets in the traffic stream currently being handled have been processed. If so, process 200 ends at block 222. Otherwise, processing shifts back to block 204 and the next packet is processed in a similar manner.

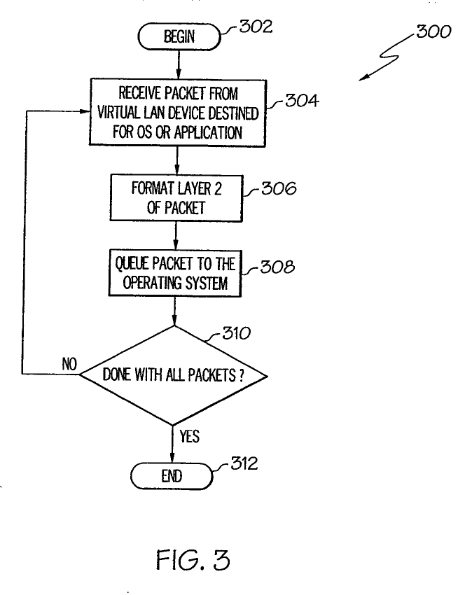

FIG. 3 is another flowchart diagram, this time illustrating a method of managing the virtual LAN relative to packets moving to the operating system or an application from a virtual device. Method 300 is used to handle a packet or packets traversing in a direction as indicated by arrow 136 of FIG. 1. Process 300 begins at block 302. At block 304, the virtual LAN system receives a packet from a virtual device destined for the operating system or an application. At block 306, the iLAN driver formats layer two of the device originated pack. At block 308, the iLAN driver queues the packet to the operating system. At block 310, the virtual LAN system makes a determination as to whether all of the traffic packets have been handled. If the system is done with all of the device originated packets in this traffic, process 300 ends at block 312. Otherwise, processing returns to block 304 where the next packet in the traffic stream is handled.

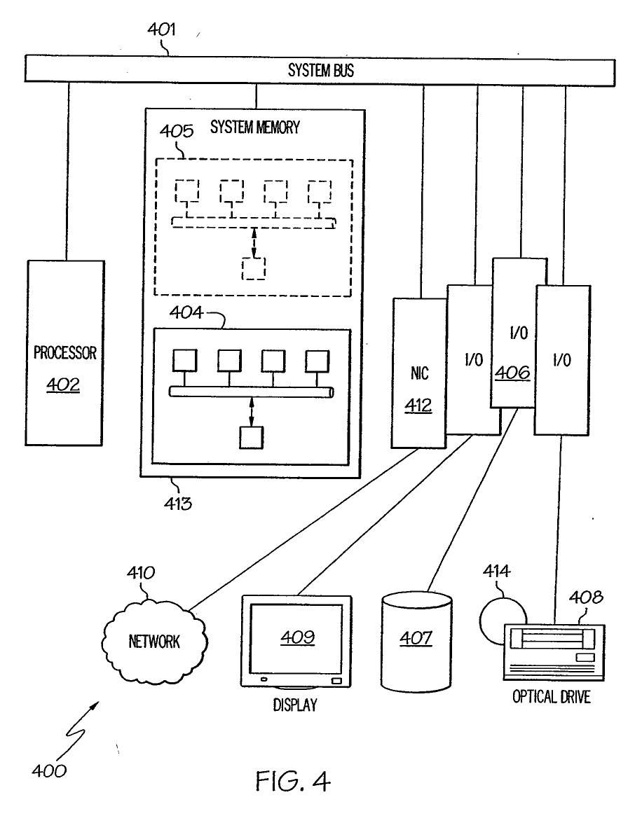

As previously discussed, in some embodiments, the invention is implemented through a computer program product operating on a programmable computer system or instruction execution system such as a personal computer, server, workstation, or the like. FIG. 4 illustrates further detail of an instruction execution system, 400, that is implementing an embodiment of the invention. The system bus 401 interconnects the components. Processor 402 controls the system. In some embodiments, processor 402 is an Intel compatible microprocessor. Note that the invention can be applied to other architectures. System memory, 403, can in some embodiments be divided into various regions or types of memory. Since an embodiment of the invention is operating in the system of FIG. 4, system memory 403 includes at least a portion of at least one internal, virtual LAN, 404. Optionally, a plurality of internal, virtual LAN's can be set up within a system. In the example of FIG. 4, a second virtual LAN, 405, is indicated by dotted lines within system memory 403. If there is more than one virtual LAN operating within an instruction execution system, the internal, virtual LAN's can be operated independently, or bridged together, in any fashion desired. Operating two virtual LAN's independently can be useful, for example, to segregate test traffic from production traffic within a system.

Still referring to FIG. 4, a plurality of general input/output (I/O) adaptors or devices, 406, are present. These adapters connect to various peripheral devices including fixed disc drive 407, optical drive 408, and display 409. In this example embodiment, system 400 is connected to network 410 via physical network interface card (NIC) 412. Computer usable program code to implement an embodiment of the invention can be encoded on optical disk 414 and transferred as needed to fixed disc drive 407. It should be noted that the system of FIG. 4 is meant as an illustrative example only. Numerous types of general-purpose computer systems are available and can be used.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A system comprising:
a plurality of internal, virtual local area network (LAN) devices, each virtual LAN device having a virtual address unique among the virtual LAN devices in the system; and
a virtual LAN driver coupled to the plurality of virtual LAN devices to transfer packets from an operating system to the virtual LAN devices using the virtual address, wherein an internal virtual LAN is formed in that the operating system can use a virtual LAN device address in the same manner as it can use a physical LAN device address.

2. The system of claim 1 wherein the virtual LAN driver can add layer two formatting to device-originated packets and the virtual address is a media access control address.

3. The system of claim 1 wherein a plurality of internal, virtual LAN's are formed.

4. The system of claim 1 further comprising a physical LAN bridged to the internal, virtual LAN.

5. A method of managing a virtual local area network (LAN) comprising:
receiving an application-originated packet through an operating system;
identifying at least one virtual device coupled to the virtual LAN using virtual address information for the at least one virtual device; and
forwarding the application-originated packet to the at least one virtual device in response to the identifying of the at least one virtual device.

6. The method of claim 5 further comprising:
receiving a device-originated packet from a virtual device; and
forwarding the device-originated packet to the operating system.

7. The method of claim 5 wherein the at least one virtual device comprises all virtual devices coupled to the virtual LAN.

8. The method of claim 5 wherein the address information comprises a media access control address.

9. The method of claim 6 wherein the address information comprises a media access control address and further comprising adding layer two formatting to the device originated packet in response to the receiving of the device-originated packet.

10. Apparatus for managing a virtual local area network (LAN) comprising:
means for receiving application-originated packets through an operating system;
means for identifying virtual devices coupled to the virtual LAN using virtual address information for the virtual devices; and
means for forwarding the application-originated packets to the virtual devices in response to the identifying of the virtual devices.

11. The apparatus of claim 10 further comprising:
means for receiving device-originated packets from the virtual devices; and
means for forwarding the device-originated packets to the operating system.

12. The apparatus of claim 10 further comprising means for forwarding broadcast packets to all virtual devices coupled to the virtual LAN.

13. The apparatus of claim 10 wherein the virtual address information comprises a media access control address.

14. The apparatus of claim 11 wherein the virtual address information comprises a media access control address and further comprising means for adding layer two formatting to the device-originated packets.

15. A computer program product comprising a computer usable medium having computer usable program code for managing at least one virtual local area network (LAN), the computer program product comprising:
computer usable program code for receiving application-originated packets through an operating system;
computer usable program code for identifying virtual devices coupled to the at least one virtual LAN using virtual address information for the virtual devices; and
computer usable program code for forwarding the application-originated packets to the virtual devices in response to the identifying of the virtual devices.

16. The computer program product of claim 15 further comprising:
computer usable program code for receiving device-originated packets from the virtual devices; and
computer usable program code for forwarding the device-originated packets to the operating system.

17. The computer program product of claim 15 further comprising computer usable program code for forwarding broadcast packets to all virtual devices coupled to the at least one virtual LAN.

18. The computer program product of claim 17 further comprising computer usable program code for discarding application-originated packets not directed to any of the virtual devices.

19. The computer program product of claim 16 wherein the virtual address information comprises a media access control address.

20. The computer program product of claim 19 further comprising computer usable program code for adding layer two formatting to the device-originated packets.
